(19) United States
(12) Patent Application Publication
(10) Pub. No.: US 2026/0216792 A1
(43) Pub. Date: Jul. 30, 2026

(54) CONVEYOR DEVICE FOR POWDER CONSTRUCTION MATERIALS

(71) Applicant: EOS GMBH ELECTRO OPTICAL SYSTEMS, Krailling (DE)

(72) Inventors: Alois LOHR, Bad Aibling (DE); Frank JUNG, Gauting (DE); Simon ERHARD, Epfach (DE)

(21) Appl. No.: 19/147,624

(22) PCT Filed: Dec. 29, 2023
(86) PCT No.: PCT/EP2023/088017

§ 371 Date: Jul. 11, 2025

(30) Foreign Application Priority Data
Jan. 19, 2023 (DE) 10 2023 101 348.3

(51) Int. Cl. B22F 12/50; B22F 10/28; B23K 26/342; B28B 1/00; B33Y 10/00; B33Y 30/00; B33Y 40/00; B65G 23/06

(52) U.S. Cl. CPC B22F 12/50; B22F 10/28; B28B 1/001; B33Y 10/00; B33Y 30/00; B33Y 40/00; B65G 23/06; B22F 2998/10; B23K 26/342

(57) ABSTRACT

Disclosed is a conveyor device for an apparatus for the additive manufacture of at least one component from a powder construction material by selective solidification of the construction material. For conveying construction material in the apparatus, the conveyor device has a chain-driven conveyor with at least one toothed wheel. At least one inter-tooth region between two adjacent teeth of the toothed wheel includes an escape space for the powder construction material. Also disclosed are an apparatus for the additive manufacture of at least one component and to a method for the additive manufacture of at least one component.

The invention relates to a conveyor device for an apparatus for the additive manufacture of at least one component from a powder construction material by means of selective at least partial solidification of the construction material, to an apparatus for additive manufacturing with a conveyor device, and to a method for the additive manufacture of at least one component.

Additive manufacturing processes are becoming increasingly relevant in the production of prototypes and now also in series production. In general, “additive manufacturing processes” are understood to mean manufacturing processes in which a manufacturing product is usually built up on the basis of digital 3D design data by the depositing of material, also known as construction material. The manufacturing products are usually and hereinafter referred to as components. They are usually, but not necessarily, built up in layers. The term “3D printing” is often used as a synonym for additive manufacturing. The production of models, samples and prototypes using additive manufacturing processes is often referred to as “rapid prototyping”, the production of tools as “rapid tooling”, and the flexible production of series components as “rapid manufacturing”.

A key aspect of additive manufacturing processes based on a powder material (“powder-based”) is the selective solidification of said powder construction material, wherein this solidification can often take place with the aid of irradiation with radiant energy, e.g. electromagnetic radiation, in particular light and/or heat radiation, but possibly also with particle radiation such as electron radiation. Examples of additive manufacturing processes that work with radiation are “selective laser sintering” or “selective laser melting”. In this process, thin layers of a mostly powder construction material are repeatedly applied on top of each other and in each layer the construction material is selectively solidified in a “welding process” by spatially limited irradiation of the areas that are to be part of the component to be manufactured after production, in which the powder grains of the construction material are partially or completely melted with the help of the energy introduced locally at this point by the radiation. During cooling, these powder grains then solidify together to form a solid body. In most cases, the energy beam is guided along solidification paths across the build area and the remelting or solidification of the material in the respective layer takes place in the form of “weld paths” or “weld beads”, so that ultimately a large number of such (component) layers formed from weld paths are present in the component.

To produce a component, a larger volume of a powder construction material is often initially provided in a process space than is actually processed to produce the component. Particularly when applying construction material in layers, but not only there, a reserve can be provided in a respective material layer in order to avoid a deficit of construction material in the component layer. In order to be able to reuse surplus, i.e. unused, construction material, additive manufacturing machines are known in which surplus construction material is collected in a first container, which is located close to a build area and is then transferred by means of a transport device to a second, larger collection container, which is typically located further away from the build area.

Known transport devices are realised, for example, as screw conveyors and can have the disadvantage that the removal of excess construction material from the heat-affected zone of the additive manufacturing machine is relatively slow. This can lead to heat-induced damage and high powder ageing, particularly with plastics-based construction materials, which has a detrimental effect on the degree of recycling. The frictional heat generated during operation of the screw conveyor can also reduce the quality of the powder. Caking of construction material can occur on the screws during operation, wherein the conveying capacity of the screw conveyor is reduced.

In transport devices with chain conveyors, there is often the problem that the powder construction material adheres to sprockets or chains and is compacted, at least at points where the chain comes into contact with a sprocket. As a result, adhesions that are difficult to remove can form, e.g. particles of the construction material that are at least partially solidified by pressure and/or heat and form agglomerates, for example. This can cause the chain to skip during operation, which can result in the conveyor coming to a standstill or becoming defective. This problem can generally exist with a chain conveyor that transports powder construction material in an additive manufacturing machine, i.e. regardless of the transport direction of the construction material in the manufacturing machine and the position of the chain conveyor within the manufacturing machine.

It is the object of the present invention to provide a conveyor device for an apparatus for the additive manufacture of a component from a powder construction material as well as such an apparatus with a conveyor device and a method for the additive manufacture of a component, with which at least some of the disadvantages mentioned can be reduced or avoided.

This object is achieved by a conveyor device according to claim 1 and an apparatus according to claim 13, as well as by a method according to claim 15.

A conveyor device according to the invention is designed to be operated in an apparatus for the additive manufacture of three-dimensional components from a powder construction material by selective at least partial solidification of the construction material. The conveyor device is designed to co-operate with other components of the apparatus, hereinafter referred to as an additive manufacturing apparatus or AM machine for short, in the additive manufacturing of a respective component. The design of the conveyor device is adapted to the conditions in a process space of the AM machine during an additive manufacturing process. The conveyor device can preferably be reversibly integrated into an AM machine. Preferably, the conveyor device can be designed as a removable machine component for equipping an AM machine.

The conveyor device is designed, in particular in the assembled state in an AM machine, to convey powder construction material in the AM machine. Conveying powder construction material means that the construction material is transported in the AM machine, in particular between two or more different locations. In the description of the invention, the powder construction material is referred to synonymously as powder.

According to one embodiment of the invention, the conveyor device can be designed, in particular can be mounted in an AM machine in such a way that powder is transported in the direction of a build area of the AM machine. In particular, the conveyor device may be designed and/or mountable in such a way that (fresh) powder is fed by means of the conveyor device to an application apparatus of the AM machine, which applies the powder to a build area in the process area of the AM machine during additive manufacturing. Consequently, the conveyor device can be designed and/or mounted in such a way that the powder construction material is transported to a processing location in the AM machine by means of the conveyor device. Accordingly, the conveyor device can be integrated into the application of construction material to the build area of the AM machine.

According to one embodiment, the conveyor device is, alternatively or additionally, designed, in particular mountable in the AM machine, in such a way that construction material can be transported away from a build area of the AM machine. In particular, the conveyor device can be designed and/or mounted in such a way that unused or excess powder is removed from the immediate vicinity of the build area. Unused or excess construction material is defined in particular as that part of the powder on the build area that is not used to form the component. When powder is applied to the build area in layers, the unused or excess construction material corresponds in particular to that portion of the powder of a particular application process that is not used to build up a powder layer. In this case, the unused construction material, also referred to as material residue, can be fed as a reserve or surplus upstream of a coater of the AM machine and discharged from the build area at the end of the application process. Alternatively or, preferably, additionally, unused construction material that was applied to the build area during a (first) powder application and was not solidified during a subsequent irradiation process can be discharged from the build area during a subsequent (second) powder application and/or by a movement of a coater of the AM machine, in particular by the coater (as unused construction material). It is also possible, for example, that some of the construction material is not applied to the build area during an application process (e.g. due to an error), but rather to an area immediately surrounding the build area, wherein this construction material is also referred to as unused construction material. Accordingly, the conveyor device can be designed and/or mounted in such a way that unused powder, in particular unconsolidated powder, is conveyed away from the AM machine's build area by means of the conveyor device. Preferably, the conveyor device can be designed and/or can be mounted in the (immediate) vicinity of the build area, so that powder which is discharged from the build area, for example after completion of an application process, and/or is discharged from the build area by a coater during a movement of the coater on the build area, can be guided away from the build area by the conveyor device.

To transport powder in the AM machine, the conveyor device has at least one chain-driven conveyor. The chain-driven conveyor comprises at least one, preferably several, chains, in particular roller chains. Furthermore, the chain-driven conveyor comprises at least one single, preferably several, toothed wheels. The respective toothed wheels are preferably realised as sprockets. The toothed wheels, in particular the sprockets, are in meshed engagement with an associated chain during operation of the conveyor. The chain-driven conveyor preferably has at least one conveyor element that co-operates with the chain and serves to move the construction material. Furthermore, the chain-driven conveyor preferably comprises a controllable drive means, e.g. an electric motor, to move the at least one chain for transporting construction material. The chain-driven conveyor can preferably be realised as a chain conveyor.

According to the invention, at least one inter-tooth region of the toothed wheel between two adjacent or circumferentially spaced adjacent teeth of the toothed wheel, preferably of the sprocket, comprises an escape space for the powder construction material. Preferably, the escape space can be formed by at least a part of the inter-tooth region of the toothed wheel itself. The inter-tooth region is an area of the toothed wheel that lies between two adjacent or successive teeth. In particular, the inter-tooth region can be a (material) region of the toothed wheel that lies between two tooth flanks of two adjacent teeth facing each other and/or between two tooth feet of two adjacent teeth.

The escape space is designed in particular in such a way that a chain in engagement with the toothed wheel is spaced apart from a material body of the inter-tooth region in the area of the escape space. This means that the meshing chain preferably does not make direct contact with the inter-tooth region in the escape space.

In particular, the escape space is designed such that a chain in engagement with the toothed wheel is spaced apart from powder construction material present in the escape space. This means that the meshing chain preferably does not directly contact the powder construction material present in the escape space.

The escape space is preferably designed to guide powder construction material, which hits the escape space during operation, away from the inter-tooth region and/or to temporarily absorb the construction material. Contact between the powder and the escape space can occur during operation of the conveyor device and/or during operation of an AM machine with the conveyor device by powder being thrown against the escape space or trickling down onto it. Accordingly, the escape space can preferably be realised in such a way that powder that hits the escape space is guided away from it by gravity, in particular by slipping.

Advantageously, with the conveyor device according to the invention, the fastest possible transport of construction material in an AM machine can be achieved, e.g. compared to known screw conveyors. This has the advantage that powder ageing can be reduced, in particular during feeding into a heat-affected zone and/or during transport away from it. This can have a favourable effect on the material properties of the fresh, i.e. still to be processed, construction material. Furthermore, the degree of recycling of the powder can be improved by rapid removal of excess construction material from the heat-affected zone.

Furthermore, critical areas of the toothed wheel that are prone to powder adhesion can be advantageously reduced compared to known toothed wheels due to the escape space. Critical areas are in particular the surface areas of the toothed wheel that are subjected to tensile and/or compressive forces by a chain during operation of the conveyor device. In the case of known apparatuses, the accumulation of powder and subsequent compaction by the chain can lead to flat, difficult-to-remove adhesions on the toothed wheel during operation, particularly in a chain contact area of the toothed wheel, which may be located in the inter-tooth region. The chain contact area corresponds to a contact zone between the toothed wheel and a meshing chain. The chain contact area is the part of a surface of the toothed wheel that is directly contacted by the chain during operation of the conveyor device. Advantageously, the surface areas of the toothed wheel where adhesions can potentially occur can be minimised as far as possible thanks to the escape space in the inter-tooth region (as a critical area). As a result, undesirable build-up on the toothed wheel can at least be reduced compared to known toothed wheels, which can have a favourable effect on proper running of the chain and trouble-free operation of the conveyor device. By reducing powder build-up and adhesions on the toothed wheel, it can also be achieved that fewer adhesions form on the chain.

An apparatus according to the invention for the additive manufacture of at least one component comprises a feed apparatus for feeding a powder construction material into a process space, an irradiation apparatus for selectively at least partially solidifying the powder construction material by irradiation with at least one energy beam and at least one conveyor device according to the invention. Preferably, the AM machine can have two or more separately controllable conveyor devices. Preferably, two conveyor devices can be arranged on opposite sides of a construction container of the AM machine.

The respective conveyor devices can have different functions in the AM machine. For example, a first conveyor device may be designed to transport (fresh) powder to a processing location in the AM machine, wherein a second conveyor device is designed to transport excess powder away from the build area of the AM machine.

A method according to the invention for additively manufacturing at least one component, preferably a plurality of components, comprises at least the following recurring steps:

In one step, a powder construction material is fed to a process space of an AM machine, in particular by applying the construction material in layers to a build area. In a further step, the construction material is selectively irradiated with at least one energy beam in order to selectively at least partially solidify the construction material to form a component layer. Preferably, the construction material of a previously applied powder layer is partially solidified by selectively irradiating areas of the powder layer, corresponding to a cross-section of the component to be produced, with the energy beam.

In a further step, construction material is conveyed in the AM machine by means of a conveyor device, in particular a conveyor device according to the invention. The conveyor device has at least one chain-driven conveyor, preferably a chain conveyor, with at least one toothed wheel, preferably a sprocket, wherein at least one inter-tooth region of the toothed wheel between two adjacent teeth of the toothed wheel comprises an escape space for the powder construction material. Preferably, the method is carried out such that powder which comes into contact with the escape space is guided away from the inter-tooth region by the escape space and/or is temporarily taken up by the escape space. Preferably, the method is carried out in an additive manufacturing apparatus according to the invention.

Furthermore, the method may provide for excess construction material, in particular of a respective powder layer, to be transferred to an intermediate container of the conveyor device. The excess construction material can be transported from the intermediate container into an overflow container, which is associated with the conveyor device, by means of the conveyor device.

Advantageously, the AM machine according to the invention, the manufacturing method and the conveyor device are based on the same inventive concept. This consists of a conveyor device for an AM machine with a chain-driven conveyor with at least one toothed wheel, wherein at least one inter-tooth region of the toothed wheel comprises an escape space for the powder construction material. This means that the AM machine and the manufacturing process also have the same advantages as described for the conveyor device.

Further, particularly advantageous embodiments and further embodiments of the invention result from the dependent claims and the following description, wherein the independent claims of one claim category can also be further developed analogously to the dependent claims and exemplary embodiments of another claim category and, in particular, individual features of different exemplary embodiments or variants can also be combined to form new exemplary embodiments or variants.

The conveyor device can be used in different AM machines, regardless of the operating principle. For a better understanding, the invention is described below, without limitation, with reference to an AM machine and a manufacturing process in which powder construction material is applied in layers to a build area and then selectively solidified. Accordingly, several material application levels or material layers can be successively built up in the AM machine or in the manufacturing process in a build area. The construction material can be a polymer-based powder. However, the invention is not limited to this, but also includes other powder construction materials. For example, metal powder, ceramic powder, filled or mixed powders, sand and mixtures of different materials can be used.

To produce a component, the construction material of a previously applied material layer is solidified by irradiating the construction material with at least one energy beam generated by the irradiation unit. This refers to an energetic beam of photons or particles, e.g. a light beam or an electron beam. In principle, the AM machine can also have several irradiation apparatuses, which can then be controlled in a coordinated manner with control data. Furthermore, the energy beam can also consist of several superimposed energy beams. Preferably, the construction material is selectively solidified in each of its layers by selective irradiation of areas corresponding to a cross-section of the component to be produced.

The AM machine preferably comprises a removable build container or exchangeable frame for holding the build material. Preferably, the build container can form the build area, in particular an area of the build container located within an opening. The AM machine preferably has a coater for applying the construction material to the build area in layers. The coater is preferably part of the feeding device. The AM machine preferably has further components that are generally known from additive manufacturing apparatuses and are therefore not described further. This relates in particular to a control device that controls all components of the AM machine for manufacturing a component, in particular in accordance with the manufacturing process described. Preferably, the control device of the AM machine can be designed to also control the operation of the conveyor device.

The additive manufacturing apparatus comprises, as described, at least one conveyor device. The conveyor device is preferably designed, in particular arranged in the process space of the AM machine, in such a way that unused or excess construction material is guided away from the build area in the process space of the AM machine. The unused or excess construction material can at least comprise construction material from a (respective) application process that is not used to build up a powder layer and/or can at least comprise construction material that was applied to the build area during a (first) powder application and was not solidified during a subsequent irradiation process and that is discharged from the build area by the coater during a subsequent (second) powder application and/or by a movement of a coater of the AM machine.

Preferably, the conveyor device can be used to transport excess construction material from an intermediate container of the conveyor device into an overflow container, which is associated with the conveyor device. The intermediate container is at least designed to hold the material residue from a single coating process. The intermediate container is preferably arranged in the immediate vicinity of the construction site. Preferably, the intermediate container can be directly adjacent or connected to the construction container. The intermediate container can extend along an entire side of the build area, e.g. along an entire longitudinal or transverse extent of the build area. In particular, the intermediate container can be arranged such that an upper side or upper edge of the intermediate container is flush with a current working plane of the AM machine or slightly below it (in the perpendicular direction).

In a corresponding manner, in a preferred production process, it can be provided that (fresh) powder is arranged in layers on the build area, wherein excess construction material, in particular of a respective powder layer, is transferred to the intermediate container of the conveyor device and wherein the excess construction material is introduced from the intermediate container into the overflow container, also referred to as a collecting container, by means of the conveyor device. To apply a layer of powder to the construction site, a coater can be guided over the construction site as a movable beam at a distance from the construction site corresponding to a planned layer thickness, thereby pushing a portion of the powder in front of it and largely consuming it. The surplus construction material, which is fed in front of the coater, can be discharged from the build container at the end of each application process and fed into the intermediate container close to the build area.

Although the conveyor device is generally designed for transporting powder construction material in an AM machine, advantageous developments of the conveyor device are described, without limitation, with reference to a conveyor device that is used to remove excess powder. DE 10 2017 126 665 A1 discloses a conveyor device with a similar purpose, albeit without the special chain-driven conveyor. Reference is made to the aforementioned application, the content of which is hereby incorporated into this application.

The AM machine can in principle have two or more conveyor devices. The respective conveyor devices can preferably be arranged in the immediate vicinity of the build area, e.g. directly adjacent to it. Depending on the working method of the coater, namely a layer build-up in only one working direction or in two opposite directions, the AM machine can comprise one or two conveyor devices. If two conveyor devices are provided, these are preferably each located behind the build container in the working direction of the coater. The invention is described below with reference to an AM machine with only one conveyor device, which in principle also covers the arrangement of several conveyor devices mutatis mutandis.

The chain-driven conveyor of the conveyor device can preferably have two, in particular four sprockets. Preferably, two sprockets are in engagement with an endless chain during operation. The invention is described below, without limitation, with reference to a roller chain (as a chain) and a sprocket (as a toothed wheel). In principle, other types of chains can also be used, such as chains in which sleeves engage with the teeth of the sprocket, chains with an offset, sealed chains or the like. The advantageous developments described with reference to a single sprocket can apply in the same way to a plurality of sprockets. It should be noted that the conveyor device can in principle also have different sprockets, in particular with regard to the design of the escape space. For example, in addition to a sprocket according to the invention, the conveyor device can also have at least one conventional toothed wheel, i.e. without the special inter-tooth region, e.g. if this toothed wheel is loaded with powder less strongly or not at all during operation due to its position.

The respective sprocket (as a toothed wheel) can preferably have two or more spaced-apart, preferably different, escape spaces for the impinging powder construction material. Preferably, an escape space can be formed between each of the two adjacent teeth of the sprocket. Preferably, a separate escape space can be arranged in each inter-tooth region of the sprocket. The invention is described below, without limitation, with reference to such a sprocket as mentioned above. Different escape spaces of the same sprocket can be designed differently.

The escape space for the impinging powder construction material can comprise a clearance in the inter-tooth region. It is possible that the escape space is realised in the form of a clearance. A clearance can preferably be formed by a specific material recess in the material body of the inter-tooth region. Different clearances can be formed in the respective inter-tooth regions.

According to one embodiment of the invention, the respective escape space can have a slip-off surface which is designed to guide construction material away from the inter-tooth region of the sprocket or to divert it away from the inter-tooth region. In particular, powder can be guided away from at least some areas of the inter-tooth region by the slip-off surface. The slip-off surface can preferably be formed by a clearance in the inter-tooth region. Preferably, the slip-off surface can be formed by the material of the inter-tooth region itself. Accordingly, the slip-off surface can be part of the inter-tooth region.

The respective slip-off surfaces are preferably formed such that powder impinging on the slip-off surface slides along the slip-off surface by means of gravity in order to be guided away from the inter-tooth region. In this embodiment, the respective slip-off surface can therefore form a kind of “sloping floor” of the escape space for the powder. The individual slip-off surfaces can preferably each be spaced apart by one tooth of the sprocket.

Preferably, a slip-off surface can be formed between each of the adjacent teeth. The slip-off surfaces of the same sprocket can generally be designed differently. Preferably, the respective slip-off surface can be formed by a tooth base between two adjacent teeth of the sprocket (as a toothed wheel). Depending on the design, the respective slip-off surface can completely connect two adjacent teeth. This means that the slip-off surface can then extend along a longitudinal extent of the tooth base from one tooth to the adjacent tooth (the longitudinal extent of the tooth base runs along a circumference, i.e. orthogonal to the radius of the sprocket).

As is generally customary, the tooth base is understood to be a (material) area of the sprocket that connects two adjacent teeth. The tooth base is the material area of the sprocket that connects two opposing tooth flanks of two adjacent teeth, in particular without a transition.

The respective tooth base of the sprocket preferably comprises an upper side that faces away from a centre point of the sprocket. This upper side of the tooth base can preferably be aligned approximately parallel to an axis of rotation of the sprocket. Preferably, one (the same) tooth base can have an upper side of the tooth base that is approximately parallel to an axis of rotation of the sprocket and at least one slip-off surface.

Preferably, the respective sprocket (as a toothed wheel) can have a material cross-section that tapers towards a respective tooth base to form the slip-off surface between two adjacent teeth. In particular, the material cross-section of the sprocket can be reduced radially outwards in the direction of a respective tooth base upper side. For example, the material cross-section can taper radially outwards, preferably towards the top of the tooth base, starting from a centre point of the sprocket or starting from another point that is radially spaced from a centre of the sprocket.

The inter-tooth region can have a clearance, in particular in the tooth base, in order to form the slip-off surface by means of the clearance. Particularly preferably, the inter-tooth region can comprise a tooth base with a tooth base upper side and a slip-off surface adjacent thereto. This means that a width and/or an area of the tooth base, in particular the upper side of the tooth base, can be reduced by a certain amount by forming the clearance (compared to an original tooth base). In principle, at least part of the tooth base can also be formed by a slip-off surface.

Advantageously, a sprocket with slip-off surfaces can be used in a simple and effective way to achieve the most trouble-free and reliable operation of the conveyor device. The tooth base is usually a critical area of the sprocket that tends to accumulate powder. Advantageously, due to the tapered material area or material cross-section, an area of the respective tooth base, in particular an area of the top of the tooth base, can be relatively small compared to conventional sprockets. As a result, the surface area of the tooth base for potential adhesions or deposits can be minimised. Preferably, the powder that hits the slip-off surface can be guided away from the slip-off surface as completely as possible by means of gravity and/or due to a rotational movement of the sprocket, whereby larger accumulations of powder are avoided. A further advantage may be that the slip-off surface, which is adjacent to the (reduced) top surface of the tooth base, can also help to guide powder away from the top surface of the tooth base.

The sprocket (as a toothed wheel) of the conveyor device can have one or more of the elements described below to form the respective slip-off surface, wherein a combination of the elements is also possible on the same toothed wheel.

The sprocket can have at least one slip-off plane as a slip-off surface, with the slip-off plane starting from the tooth base. Preferably, the slip-off plane can have its origin in the tooth base and/or can contact the tooth base. In particular, the slip-off plane can (directly) connect to the top of the tooth base. The slip-off plane is preferably formed by a (material) area of the sprocket that extends radially or obliquely radially inwards from the tooth base, in particular from the top of the tooth base, i.e. in the direction of the axis of rotation of the sprocket.

Preferably, a (respective) slip-off plane can have two or more (partial) areas as a slip-off surface, wherein the individual (partial) areas are designed differently, in particular geometrically. These (partial) areas can, for example, adjoin each other in a radial direction, i.e. form different “radial portions” of the slip-off surface.

Preferably, the slip-off plane can be arranged at an angle to the longitudinal extent of an adjacent tooth. For example, the slip-off plane can form an inclined surface in relation to a longitudinal tooth extent. The tooth longitudinal extent is understood to be the longest extent of a tooth in the radial direction.

Preferably, the slip-off plane is inclined with respect to a tooth longitudinal extent, in particular with respect to its longitudinal extent. An angle of inclination can, for example, be at least 30°, preferably at least 40°, preferably at least 45°, particularly preferably at least 50°, in particular 60° or more, in relation to the longitudinal extent of an associated tooth. The slip-off plane can have a constant angle of inclination in relation to its longitudinal extent. It would also be possible for the slip-off plane to have different angles of inclination in relation to its longitudinal extent.

The longitudinal extent of the slip-off plane or slip-off surface is understood to be the longest extent of the slip-off plane starting from the tooth base, preferably the top of the tooth base, in the direction of the axis of rotation of the sprocket, i.e. in a radial or oblique radial direction. For example, the sprocket can have a material cross-section in the form of a right-angled trapezoid in the area of the slip-off plane. A short base side of the trapezoid can then form the upper side of the tooth base, with a leg (not orthogonal to the base side) forming the slip-off plane.

Alternatively or additionally, the sprocket (as a toothed wheel) can have at least two slip-off planes as slip-off surfaces starting from the same tooth base, which are arranged on opposite sides of the sprocket at an angle to the longitudinal extent of the tooth, forming a specific angle to each other. Accordingly, the two slip-off planes each form a specific, even different, angle to the longitudinal extent of the tooth.

In this embodiment, the inter-tooth region then comprises two separate slip-off planes or slip-off surfaces, which together form the escape space. The two slip-off planes can contact each other directly, forming the top of the tooth base. In this case, the material thickness of the tooth base (at least in some areas) can be many times less than the material thickness of the teeth, particularly in the area of a tooth foot.

However, it is also possible in principle for the two slip-off planes to extend on both sides of a tooth base (without forming the top of the tooth base itself). For example, the sprocket can have a material cross-section in the form of an isosceles trapezoid in the inter-tooth region. A short base side of the trapezoid can then form the tooth base, in particular the upper side of the tooth base, with one leg forming a slip-off plane in each case.

Preferably, an (internal) angle between a respective slip-off plane and a tooth longitudinal extent (i.e. in the radial direction of the toothed wheel or in a direction perpendicular to the axis of rotation of the sprocket) can be at least 15°, preferably at least 30°, preferably at least 45° and/or at most 75°, preferably at most 65°, particularly preferably at most 60°. In principle—as will be explained later—the angle of inclination of the slip-off plane in an inter-tooth region can also change in a radial direction (in relation to a direction perpendicular to the axis of rotation of the sprocket), e.g. in sections or continuously (in the form of an arc).

For example, the toothed wheel can have at least one curved, preferably concave, slip-off plane extending from the tooth base, in particular from the top of the tooth base, as a slip-off surface. Preferably, the slip-off plane can be concave at least in sections along its longitudinal extent. Alternatively or additionally, the slip-off plane can have a curved, in particular concave, surface in a transverse extent that runs orthogonally to the longitudinal extent of the slip-off plane. A radius of curvature of a (concave) slip-off surface in the direction of the (radially extending) longitudinal extent and/or the transverse extent can, for example, be in a ratio with the toothed wheel radius of at least 1:8, preferably at least 1:4, particularly preferably 1:2 and/or at most 8:1, preferably at most 4:1, particularly preferably 2:1.

Preferably, a curvature and/or an inclination of a slip-off plane can be compatible with other design parameters of the toothed wheel or can be adapted thereto. For example, a height of the slip-off plane in the radial direction, i.e. in a direction perpendicular to the axis of rotation, can be influenced by a certain curvature or by a certain inclination of the slip-off plane and a thickness of the toothed wheel. If geometric conditions are specified, e.g. that the inclination is to take place over a certain radial portion according to a radius of curvature, even one parameter can also be determined indirectly by the other parameters. For example, if two parameters (thickness and curvature or inclination) are defined, a third (height) can be given automatically. In other words, a curvature or inclination of the slip-off plane can only be set within certain limits for a certain height of the slip-off plane in the direction in which the toothed wheel extends and for a certain thickness of the toothed wheel.

Preferably, the slip-off surface or the slip-off plane is as steep as possible at its free end (facing the outer edge of the sprocket). The height of the slip-off plane and/or the curvature and/or the inclination of the slip-off plane and/or the thickness of the toothed wheel can be selected in such a way that the steepest possible free end of the slip-off surface is realised.

As mentioned, a slip-off plane can have at least two different angles of inclination relative to its longitudinal extent, i.e. the slip-off plane has at least two “radial portions” in the radial direction, which are inclined differently relative to the radial direction of the toothed wheel. Preferably, a certain section of the slip-off plane, which comprises the free end of the slip-off plane, is steeper along the longitudinal extent of the slip-off plane than another section along the longitudinal extent of the slip-off plane. This is realised, for example, by an angle of inclination to the axis of rotation of the toothed wheel of a section comprising the free end of the slip-off plane along the longitudinal extent of the slip-off plane being greater than the angle of inclination to the axis of rotation of the toothed wheel of another section of the slip-off plane.

A steep slip-off surface end is achieved with a concave curvature with a relatively large radius of curvature and with a relatively small thickness of the toothed wheel.

In addition, other non-straight and/or non-circular (circular arc-shaped) slip-off planes (both in the longitudinal and transverse extent, i.e. in the circumferential direction) are possible. For example, parabolic, elliptical, hyperbolic and/or exponential slip-off planes can be realised. A curved, non-circular slip-off plane can be compatible with or adapted to other design parameters of the sprocket, analogous to the slip-off planes already disclosed herein.

Particularly in the case of non-circular, curved slip-off planes, a further design parameter can be a distance between a position on the toothed wheel (e.g. from the end of the tooth and/or from the centre of the toothed wheel) and the (virtual) origin of a curved slip-off plane. The origin of a (virtual) curved surface in three-dimensional space is generally understood to be a point that lies at the minimum of the surface in three-dimensional space. A curved slip-off plane can in turn be defined or described by a partial area of such a curved surface in three-dimensional space. The position of the origin relative to the toothed wheel can also (co-) determine which part of the (virtual) curved surface defines the real slip-off plane. In particular, the position of an origin of the curved surface in the radial and axial direction (running along the axis of rotation) of the toothed wheel can also be used to define the course of the surface of the slip-off plane along a radial direction of the toothed wheel.

In a (fictitious) three-dimensional representation, the origin of a slip-off plane can in particular also lie outside the volume of the toothed wheel.

Preferably, in the case of a concavely curved slip-off plane, the origin is arranged in such a way that a radially inner end of the slip-off plane is as steep as possible (i.e. the incline is as steep as possible in a radially inner area with respect to the radius of the toothed wheel). A steep slip-off plane end can be achieved at a small distance between a position on the toothed wheel (e.g. from the end of the tooth and/or from the centre of the toothed wheel) and the origin of the slip-off plane. In particular, it is advantageous—as will be shown later with reference to an exemplary embodiment in the figures—for the origin of a parabola (serving to define the slip-off plane) and/or an ellipse and/or a hyperbolic and/or exponential function to be lower in comparison with the height of the slip-off plane (i.e. the origin is lower in the radial direction than the end of the slip-off plane), so that the slip-off plane is as steep as possible at the end of the slip-off plane.

For the sake of completeness, it should be noted that it is also possible for at least one slip-off plane (or both) to have a curvature in the case of an inter-tooth region with two slip-off planes (pointing to two sides of the toothed wheel facing away from each other). For example, the material cross-section of the toothed wheel in the inter-tooth region can be double concave and/or convex to form the slip-off planes. The curvature of the two slip-off planes can be different, for example according to the embodiments explained above and combinations thereof.

In principle, the respective slip-off plane can also be only partially curved and/or partially inclined, irrespective of the further configuration of the inter-tooth region. In other words, the slip-off plane can, for example, have different radial portions that are inclined or curved differently in the radial direction.

Furthermore, the respective upper side of the tooth base, which points away from a toothed wheel centre, can be concave at least in sections, regardless of the further configuration of the inter-tooth region.

The slip-off surface or the slip-off plane can, for example, be realised in the form of a curved recess in the material body of the sprocket. Preferably, the slip-off surfaces or slip-off planes can each be pocket-like. Preferably, at least one pocket can extend from the tooth base, in particular from the top of the tooth base, in the shape of a tongue in the direction of a sprocket centre point. Preferably, the pocket can be curved at the end, i.e. pointing in the direction of the sprocket centre, or form a semicircle. An arcuate pocket or a semi-circular pocket can be realised according to the embodiments explained above or combinations thereof. As mentioned, not only a straight, but also an arcuate design of the slip-off planes in the transverse extent, i.e. in the circumferential direction of the toothed wheel, is possible, wherein different shapes can also be selected here in sections in the circumferential direction or circular sector. In other words, the entire three-dimensional surface of the slip-off plane can be optimised for the respective application.

The sprocket of the conveyor device is preferably designed such that a ratio between the radial longitudinal extent of the slip-off surface (calculated from the radially inner slip-off surface end to the tooth base surface), in particular the slip-off plane, and a radial longitudinal extent (tooth longitudinal extent) of an associated tooth (calculated from the tooth base surface to the radially outer end of the tooth) is at least about 1:2, preferably at least about 1:1.5 and/or at most about 1:0.25, preferably at most about 1:0.5. An associated tooth is preferably a tooth that is adjacent to the slip-off surface.

The sprocket of the conveyor device can be designed such that a ratio between the longitudinal extent of the slip-off surface (calculated from the radially inner end of the slip-off surface to the tooth base surface), preferably the slip-off plane, and a radius of a wheel body of the toothed wheel or of the sprocket (i.e. the radial distance between the axis of rotation of the toothed wheel and the tooth base surface) is at least 1:10, preferably at least 1:5 and/or at most 1:1.5, preferably at most 1:2. Preferably, the ratio between the longitudinal extent of the slip-off surface or slip-off plane and the radius of the wheel body of the toothed wheel can be approximately 1:3.

The wheel body is understood to be a main body of the sprocket without the outer teeth arranged thereon. The wheel body can preferably have a circular outer circumference. Preferably, the wheel body is defined by the base circle of the sprocket.

Advantageously, in the case of a conveyor device with the slip-off planes described above, the impinging powder can be guided away from the inter-tooth region particularly reliably. Furthermore, slip-off planes with a large longitudinal extent can have the advantage that they can be formed comparatively easily in the sprocket, wherein the sprocket can be manufactured more economically.

According to one embodiment of the invention, the respective escape space for the construction material can comprise a clearance in the inter-tooth region, which is formed in such a way that a certain distance between a chain roller of a chain, which is in engagement with the sprocket, and the tooth base of the inter-tooth region is formed by the clearance. In other words, the clearance can be designed in such a way that there is no (direct) contact between the meshing chain and the tooth base in the inter-tooth region (in the area of the clearance). As described, a clearance is understood to mean a specific material-free space in the material body of the sprocket or a specific material recess in the inter-tooth region of the sprocket.

The clearance can preferably be formed in the tooth base itself. This means that the tooth base can be “lowered” at least in sections by the clearance. Preferably, the top of the tooth base can be shifted slightly towards the centre of the sprocket (relative to an inter-tooth region without such a clearance) by the clearance. Preferably, such a clearance can be formed in combination with a previously described slip-off surface.

Furthermore, it is possible that the escape space for the construction material comprises a clearance which is designed in such a way that a chain in engagement with the sprocket, in particular a chain roller in engagement with the sprocket, is supported (only) via two contact areas on two opposing teeth. The clearance, preferably the sprocket, can be designed in such a way that a certain distance is formed between a chain roller of the chain in engagement with the sprocket and the wheel body of the toothed wheel or the sprocket body.

Preferably, the sprocket is designed in such a way that the chain is then only in engagement with the sprocket via the teeth, with no (direct) contact between the chain and the (remaining) sprocket in the inter-tooth region, in particular in the area between two adjacent tooth feet. Accordingly, the respective chain roller then only contacts the toothed wheel via two defined contact areas of the teeth. The clearance can extend along the entire length of the inter-tooth region.

The contact areas for supporting the chain roller can preferably be on the tooth flanks facing each other of two consecutive teeth. Preferably, a distance between the two contact areas of the opposing teeth is smaller than a diameter of the chain roller of the chain. In particular, the sprocket is realised in such a way that the clearance does not exceed the radius of the involute transition. Preferably, the grip conditions of the toothing are observed.

A sprocket with this type of clearance generally has no tooth base. This means that the individual teeth can be arranged on the wheel body of the sprocket, in which case there is no direct connection between the tooth flanks of adjacent teeth. Instead, the tooth flanks can be adjacent to the wheel body or a tooth foot. The teeth of the sprocket are arranged quasi isolated on the wheel body, wherein a material-free space (as a clearance) is formed between two adjacent teeth, which extends to the wheel body.

Alternatively or additionally, the sprocket, in particular the clearance, can be designed in such a way that an engaged chain, in particular a chain roller, is supported (only) via two contact areas on two opposing teeth, wherein a certain distance is formed between a chain roller of the chain and a (lowered) tooth base.

Advantageously, a sprocket with such a clearance can be used to prevent unwanted adhesion to the sprocket particularly effectively. Due to the clearance, the chain only rests on the teeth themselves, wherein there is no direct contact between the chain and the remaining sprocket in the inter-tooth region during operation of the conveyor. This prevents the compression of any powder that may be present in the inter-tooth region.

Advantageously, the chain runs stably during operation despite such clearances in the sprocket.

It should be noted that it is possible to combine different powder escape spaces on the same sprocket. In principle, it could also be provided that at least one inter-tooth region does not have an escape space for powder. Furthermore, a conveyor device according to the invention can have different sprockets, in particular sprockets with different powder escape spaces.

It is optionally possible to design the sprocket such that the sprocket as a whole is shaped such that its outer basic shape (irrespective of spaces between the teeth) already has a radius of curvature and/or an inclination. For example, at least one side of the sprocket can have a radius of curvature and/or an inclination in the radial direction, in each case starting from the teeth to the centre point. The entire curved and/or inclined (radial) surface of the sprocket can then form a slip-off surface for powder hitting it. For example, at least one side of the toothed wheel can have a concave surface. In principle, it is also possible for only a certain part or section of the sprocket or the sprocket surface to have a curvature and/or an inclination. A curvature can, for example, be circular (arc of a circle), parabolic, hyperbolic or exponential. Combinations of these curvatures are also possible. The teeth can have a different inclination or curvature than the rest of the sprocket.

Optionally, the conveyor device can have a scraper plate for powder, wherein the scraper plate is associated with the sprocket. The scraper plate can be designed to scrape off construction material adhering to the side of the sprocket during operation. Accordingly, the scraper plate can be arranged transversely, substantially orthogonally, to a longitudinal tooth extent. Depending on the design of the sprocket, the scraper plate can optionally have a degree of curvature that is adapted to a radius of curvature and/or an angle of inclination of the sprocket. In principle, a separate scraper plate can be assigned to each toothed wheel of the conveyor device. The respective scraper plate can optionally have elastic scraper elements, e.g. bristles or the like. Advantageously, a scraper plate can be used to keep the lateral, in particular radial, areas of the sprocket as free as possible from powder during operation. This can also improve the effectiveness of powder removal via the slip-off planes. For example, the scraper plate can mechanically support the removal of powder from pocket-like slip-off surfaces.

Optionally, the sprocket can be designed such that a base surface of a respective tooth tip, which points away from the centre of the sprocket, corresponds to at most 50%, preferably at most 40%, preferably at most 30%, in particular at most 20%, of a base surface of a tooth base. The tooth tip can preferably be flat and can be transverse, e.g. approximately orthogonal, to the longitudinal extent of the respective tooth. The tooth base of a tooth corresponds to the area that results from a cross-section through the tooth foot in the contact area with the wheel body. Advantageously, by reducing the tooth tips, e.g. in two dimensions, a surface pressure between the sprocket and the chain can be increased during operation. This allows powder to be pressed out of the chain contact area. Alternatively or additionally, a width of the entire toothed wheel, and thus also of the teeth, could also be reduced, e.g. in relation to the chain, in order to increase surface pressure.

As described at the outset, the conveyor device can have at least one intermediate container for holding construction material. The intermediate container is preferably designed to temporarily hold and/or transport, in particular excess, construction material in the AM machine.

Preferably, the conveyor device can be designed in such a way that the chain-driven conveyor, preferably the chain conveyor, acts as intended in the intermediate container. In particular, the chain conveyor can act along a longitudinal extent of the intermediate container. The chain-driven conveyor can be arranged at least partially in the intermediate container. The intermediate container is preferably channel-like or trough-like.

An upper side of the intermediate container, which faces upwards (against the direction of plumbing) when used as intended, can preferably be open. Preferably, the upper side can have an opening along the entire length of the intermediate container for receiving the powder. Preferably, the transport of powder (supply or removal) in the AM machine may involve moving the construction material within the intermediate container by means of the chain-driven conveyor. The intermediate container can have an incline, in particular a slope in the direction of a destination for the powder.

The intermediate container can preferably be realised as part of the conveyor device, whereby the other components of the conveyor device, in particular the chain-driven conveyor, can be detachably coupled to it. Preferably, the conveyor device and the intermediate container form a module that can be reversibly mounted in an AM machine.

The intermediate container is preferably designed to receive the unused material residue of at least one coating process, preferably several coating processes, i.e. a partial quantity of the material residue that accumulates during an entire manufacturing process of the component to be produced. The material residue can then be discharged from the intermediate container to the overflow container by means of the conveyor device, so that the intermediate container is available, at least partially emptied, to receive a new material residue. Preferably, the intermediate container can be mounted in the AM machine in such a way that it can be coupled to the overflow container for transferring the powder. The overflow container is preferably designed to hold excess powder from an entire manufacturing process with a large number of application processes until the completion of a number of components. The overflow container can be part of the conveyor device or part of the AM machine.

The intermediate container, in particular with the chain-driven conveyor, can preferably extend along one (entire) side of the build container. The intermediate container can have an elongated, in particular flat, basic shape, whereby the intermediate container can be arranged in relation to the construction container in such a way that a longitudinal extent of the intermediate container is parallel to an (outer) wall of the construction container.

Preferably, the intermediate container is arranged with its longitudinal extent substantially orthogonal to the working direction or direction of movement of the coater.

The chain-driven conveyor can be realised in different ways, wherein the invention is not limited to a specific design. The chain-driven conveyor can operate continuously or intermittently.

According to one embodiment, the conveyor device can comprise a chain conveyor running along the longitudinal extent of the intermediate container. The chain conveyor can preferably have two (pull) chains running continuously in a transport direction or conveying direction, each with an upper and a lower run. It can preferably be designed in the form of a scraper conveyor or a trough chain conveyor. Both allow the powdery material residue to be fed through the empty, returning upper chain run onto the lower load run. This means that the depth of the intermediate container can be fully utilised, especially when the material residue is fed onto the conveyor in a surge-like manner. Alternatively, the chain conveyor can also be designed for two-sided removal of the material residue by arranging a horizontal intermediate plate between the upper and lower runs over a section of the longitudinal extent of the intermediate container so that the upper runs also become load runs in the area of the intermediate plate. While the scraper conveyor can transport the material residue with supports (as conveying elements) attached to the circulating pull chains transverse to a conveying direction, the pull chains and their crossbars and/or supports (as conveying elements) attached to them can run completely in the conveying flow on the trough chain conveyor. This allows the trough chain conveyor to offer a particularly space-saving design.

A preferred chain conveyor can have four sprockets that are mounted in pairs on two shafts that are connected via two endless roller chains. Preferably, all four sprockets can then have inter-toothed areas with a previously described escape space. During additive manufacturing, in particular as a result of the discharge of excess powder from the build area, the sprockets and chains are regularly exposed to powder. Advantageously, large quantities of powder can also be reliably discharged from the sprockets via the special sprockets, whereby smooth operation is possible. This advantage, in combination with the space-saving design and the sufficiently large conveying capacity of the chain conveyor, can have a favourable effect on the efficiency of the AM machine.

In principle, the chain conveyor can also be operated intermittently as a continuous conveyor. It can therefore be put into operation as soon as a material residue is discharged into the intermediate container after a coating process. As soon as the intermediate container is completely empty, the conveyor can be switched off, for example, if the time interval until the next material residue from another coating process is fed in is sufficiently long.

The chain-driven conveyor, preferably the chain conveyor, can have one or more conveyor elements that can be moved in the intermediate container along its longitudinal extent, in particular in relation to an outlet opening of the intermediate container. Preferably, several conveying elements for powder, e.g. conveying plates, can be attached to both chains of the chain conveyor at regular intervals. The conveying elements can be in the form of supports which are attached to the two roller chains transversely to a conveying direction. The supports can be guided over a base of the intermediate container (or just above it) in order to transport the powder in the conveying direction, i.e. towards a destination, e.g. to an outlet opening. The outlet opening is preferably arranged at one end of the elongate intermediate container. Preferably, one of the two shafts of the chain conveyor can be arranged above the outlet opening.

According to one embodiment, the conveyor device can have an alternately operated chain-driven conveyor with at least one conveyor element that can be moved alternately in the intermediate container along its longitudinal extent. The conveyor does not convey continuously, but at individual intervals. This makes it suitable for intermittent operation and for adjusting its conveying capacity during operation. The conveyor can have several supports that can move back and forth in one conveying direction and in an opposite direction (as conveying elements), which are arranged transversely in the conveying direction and rotatable through 90°. Because they run on the same track both in the conveying direction and in the opposite direction, this conveyor requires less space in the intermediate container. This means that a larger area of the intermediate container can be used to hold powder.

The conveyor can have a conveying element that can move alternately along the longitudinal extent of the intermediate container, which can extend horizontally and include lamellae that protrude downwards and at an angle in the conveying direction. The lamellae protrude into the material residue and push it in the conveying direction. In the opposite direction, the lamellae slide over the powdery material residue. The lamellae can also be perforated, e.g. in the shape of a frame. This allows the powder to pass through the lamellae when the conveying element moves in the opposite direction so that it is not transported. The scraper or lamella plate as a conveying element only needs to have a low overall height, which means that the installation space of the intermediate container is almost completely available for holding the material residue.

Preferably, the conveyor device can comprise a drive with a coupling gear, which is designed to drive the alternately operated chain conveyor, in particular the alternately movable conveying element, in a slow forward motion in the conveying direction and in a fast return motion in the opposite direction. This allows the conveying capacity to be increased by utilising the inertia of the material residue. This is because the material residue is fully set in motion in the slow-moving conveying direction. In the fast-moving opposite direction, on the other hand, the material residue remains largely motionless due to its inertia.

The drive of the conveyor device can alternatively or additionally comprise a coupling gear, which is designed to lower the alternately operated chain conveyor, in particular the alternately movable conveyor element, in the conveying direction and raise it in the opposite direction. In this way, the lamellae dip into the material residue in the conveying direction in order to transport it efficiently. In the opposite direction, on the other hand, the lamellae lift out of the material residue so as not to move it. This gives the conveying element a more balanced movement profile with the same efficiency, which causes less wear.

In principle, a combination of the conveying principles described above is also possible in the conveyor device.

If the intermediate container has a flat design, the construction container can be removed from the AM machine through the intermediate container without the overflow container hindering the removal. This makes it possible to guide the construction container through a protective gas lock before it is removed and to arrange the overflow container at a location in the apparatus that is more easily accessible to an operator. The arrangement of the protective gas lock serves to make operation of the apparatus more cost-effective, while the new arrangement of the overflow container makes it easier to operate.

The conveyor device can preferably be mounted or installed in the AM machine in such a way that the conveyor device can be moved at least partially, in particular the intermediate container, between a working position and a service position. For example, the conveyor device can be swivelled and/or displaced. For example, the build container of the AM machine can then be removed from the AM machine in a direction towards the working position of the intermediate container. During machine downtimes, i.e. outside of a manufacturing process, the conveyor device, in particular the intermediate container, can be moved from the working position to the service position, e.g. upwards into an empty space in the process area. This can create (additional) space for removing the build container. As a result, the conveyor device and/or the intermediate container can be larger than with a rigid conveyor device.

The AM machine can include a temperature lock to generate a temperature difference in the conveyor device, in particular to generate a temperature difference between the intermediate container and the associated overflow container. Devices such as constrictions of a passage cross-section or strip curtains in the transport path between the intermediate container and the overflow container are suitable as a temperature lock. This can reduce heating beyond the construction container and the intermediate container located next to it.

Advantageously, a temperature lock can be used to achieve a difference between an average maximum temperature of the powder in the intermediate container and in the overflow container of at least 30° C., preferably at least 50° C., more preferably at least 100° C., particularly preferably at least 200° C. A comparatively low temperature of the powder in the overflow container can have an advantageous effect on the degree of recycling.

The invention is explained in more detail below with reference to the attached figures using exemplary embodiments. In the various figures, identical components are labelled with identical reference numerals. The figures are generally not to scale and show:

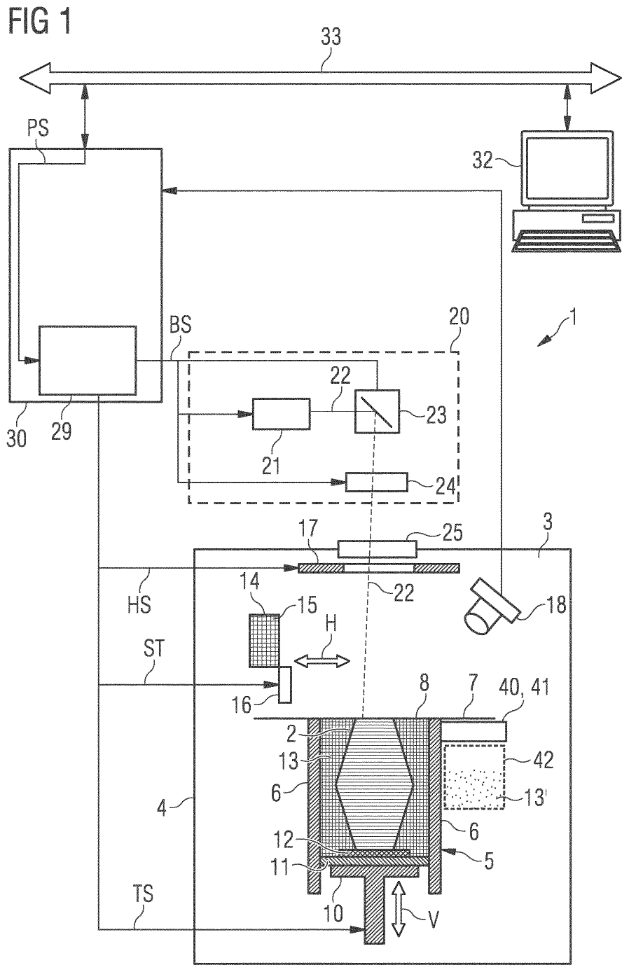

FIG. 1 a schematic view, partially shown in section, of an exemplary embodiment of an apparatus for additive manufacturing,

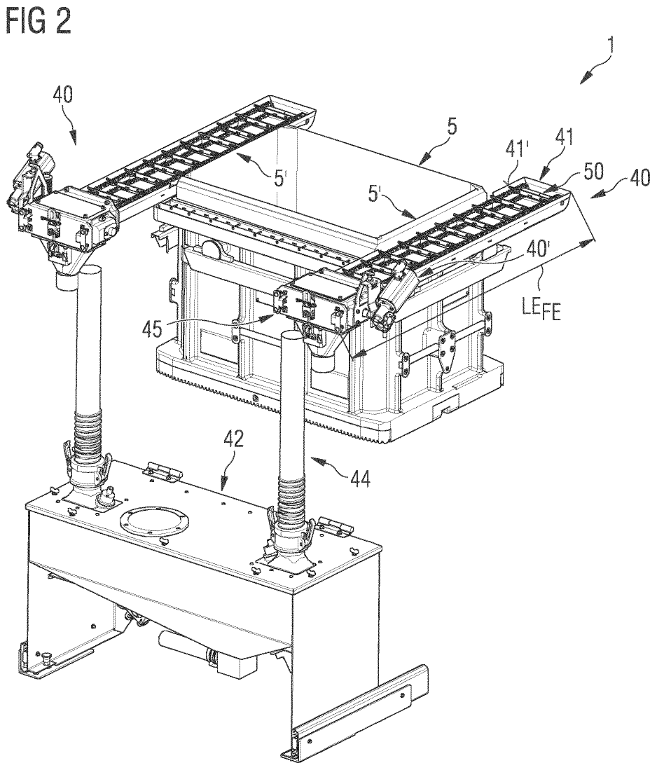

FIG. 2 a perspective view of parts of an additive manufacturing apparatus with two conveyor devices according to the invention,

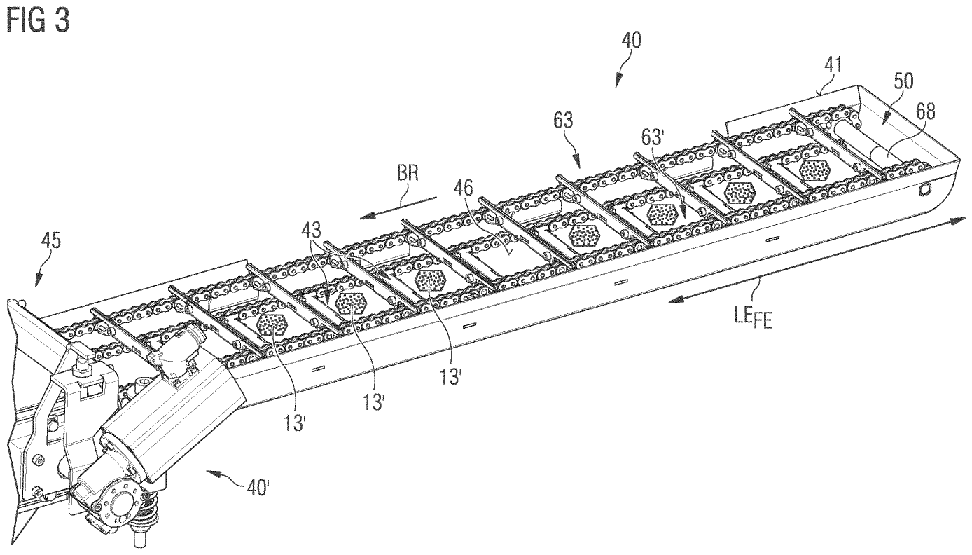

FIG. 3 a perspective and partially schematic view of parts of a conveyor device from FIG. 2,

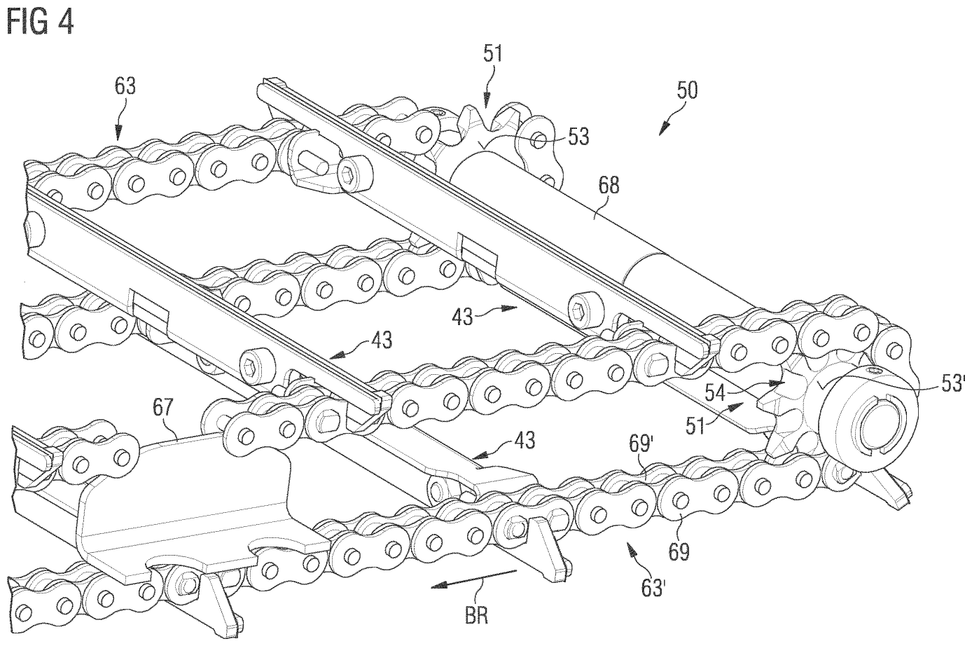

FIG. 4 a perspective view of a part of a chain conveyor of the conveyor device from FIG. 3,

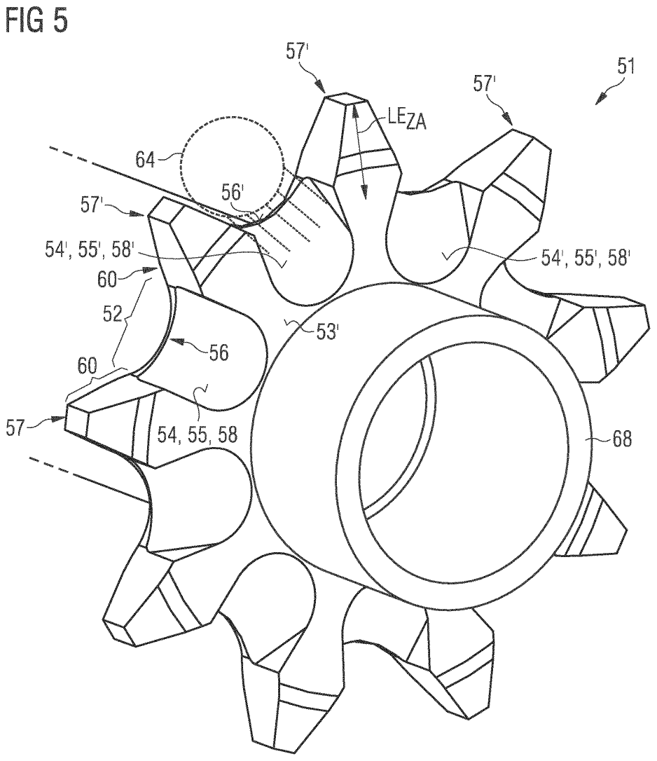

FIGS. 5 to 7 different views of sprockets according to the invention,

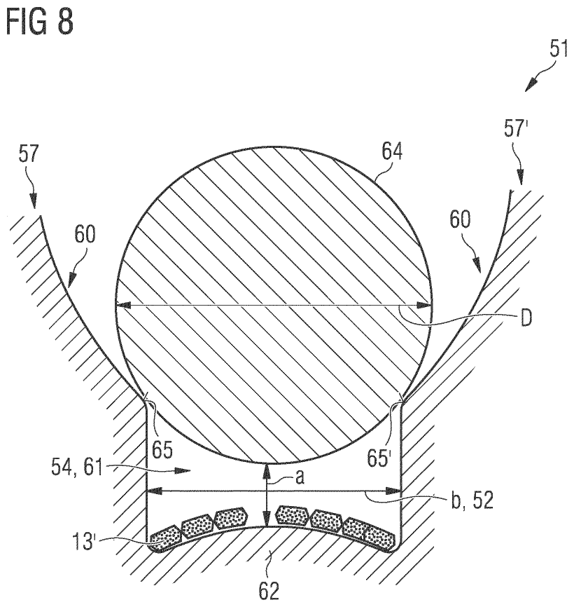

FIG. 8 a schematic view of a part of a sprocket according to the invention,

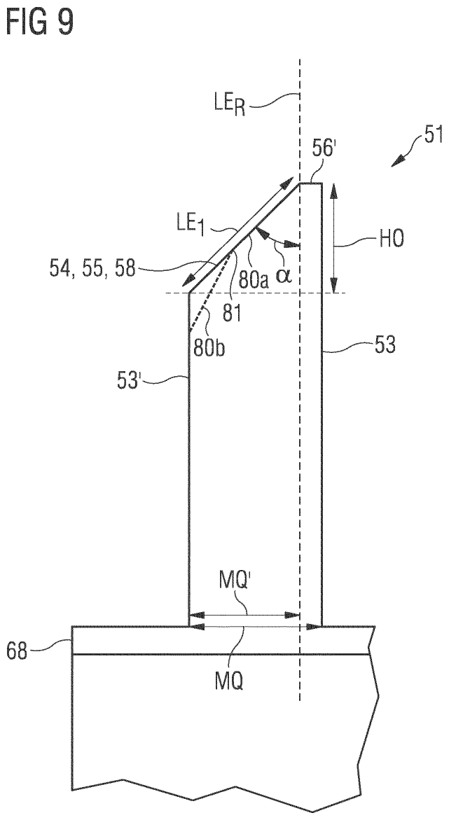

FIGS. 9 to 11 schematic views of parts of sprockets according to the invention.

FIG. 1 schematically describes an apparatus 1 for additive manufacturing or an AM machine for producing components 2 in the form of a selective laser sintering or laser melting apparatus 1, wherein the invention is not limited to selective laser sintering or laser melting apparatuses. The apparatus 1 is referred to below-without limiting the generality-briefly as a laser sintering apparatus 1.

The laser sintering apparatus 1 has a process chamber 3 or a process space 3 with a chamber wall 4, in which the manufacturing process substantially takes place. In the process chamber 3 there is an upwardly open construction container 5 or container 5 for short with a container wall 6. The upper opening of the container 5 forms the current working plane 7. The area of this working plane 7 within the opening of the container 5 can be used to build up the object 2 and is therefore referred to as the build area 8.

The container 5 has a base plate 11 that can move in a vertical direction V and is arranged on a support 10. This base plate 11 closes the container 5 at the bottom and thus forms its base. The base plate 11 can be formed integrally with the support 10, but it can also be a plate formed separately from the support 10 and attached to the support 10 or simply mounted on it. Depending on the type of specific construction material, for example the powder used, and the manufacturing process, a build platform 12 can be attached to the base plate 11 as a construction base on which the object 2 is constructed. In principle, however, the object 2 can also be built on the base plate 11 itself, which then forms the build substrate.

The basic construction of the object 2 is carried out by first applying a layer of construction material 13 to the build platform 12, then—as explained later—selectively solidifying the construction material 13 with a laser beam 22 as an energy beam at the points which are to form parts of the object 2 to be produced, then lowering the base plate 11, and thus the build platform 12, with the aid of the support 10 and applying a new layer of the construction material 13 and selectively solidifying it, and so on. In FIG. 1, the object 2 built up in the container 5 on the build platform 12 is shown below the working plane 7 in an intermediate state. It already has several solidified layers, surrounded by unconsolidated construction material 13. Various powders or mixtures of different powders can be used as construction material 13. Even if only a single component 2 is shown in FIG. 1, it is possible and usually common to produce several objects in parallel in the process chamber 3 or in the container 5. For this purpose, the construction material is scanned layer by layer by the energy beam at points that correspond to the cross-sections of the objects in the respective layer.

Fresh construction material 15 is arranged in a storage container 14 of the laser sintering apparatus 1. With the aid of a coater 16 that can be moved in a horizontal direction H, the construction material can be applied in the working plane 7 or within the build area 8 in the form of a thin layer. Optionally, there is an additional radiant heater 17 in the process chamber 3 for heating the applied construction material 13.

For selective solidification, the laser sintering apparatus 1 has an irradiation apparatus 20 or, more specifically, an exposure apparatus 20 with a laser 21. The laser 21 generates a laser beam 22 or energy beam 22, which is deflected by a deflection apparatus 23 or a scanner 23 in order to scan the exposure paths or tracks (hatch lines) in the layer to be selectively solidified in accordance with the exposure strategy and to selectively introduce the energy. Furthermore, this laser beam 22 is suitably focused on the working plane 7 by a focusing device 24. The irradiation apparatus 20 is located here outside the process chamber 3 and the laser beam 22 is guided into the process chamber 3 via a coupling window 25 arranged in the chamber wall 4 at the top of the process chamber 3.

The irradiation apparatus 20 can, for example, comprise not just one but several lasers 21. Preferably, these can be gas or solid-state lasers or any other type of laser such as laser diodes, in particular VCSEL (Vertical Cavity Surface Emitting Laser) or VECSEL (Vertical External Cavity Surface Emitting Laser) or a line of these lasers. Particularly preferably, one or more CO and/or CO2 lasers can be used in the context of the invention.

The laser sintering apparatus 1 also contains a sensor arrangement 18 which is suitable for detecting process radiation emitted in the working plane 7 during the impact of the laser beam 22 on the construction material 13. This sensor arrangement 18 operates with spatial resolution, i.e. it is capable of detecting a type of emission image of the respective layer. The sensor arrangement 18 can have an image sensor or a camera 18. Alternatively or additionally, one or more sensors could also be used to detect optical and/or thermal process radiation, e.g. photodiodes that detect the electromagnetic radiation emitted by a melt pool under an impinging laser beam, or temperature sensors for detecting emitted thermal radiation (so-called melt pool monitoring). The signals recorded by the sensor arrangement 18 can be transferred to a control device 30 of the laser sintering apparatus 1 as a process space sensor data set or layer image.

The laser sintering apparatus 1 has a control device 30, which is also used to control the various components of the laser sintering apparatus 1 for overall control of the additive manufacturing process. The control device 30 comprises a control unit 29, which controls the components of the irradiation apparatus 20, namely here the laser 21, the deflection apparatus 23 and the focussing apparatus 24, and for this purpose transmits corresponding irradiation control data BS to them.

The control unit 29 also controls the radiant heater 17 by means of suitable heating control data HS, the coater 16 by means of coating control data ST and the movement of the support 10 by means of support control data TS and thus controls the layer thickness.

The control device 30 is coupled, here for example via a bus 33 or another data connection, to a terminal 32 with a display or the like. Via this terminal 32, an operator can control the control device 30 and thus the entire laser sintering apparatus 1, e.g. by transmitting process control data PS.

The laser sintering apparatus 1 has a conveyor device 40, shown purely schematically, which is arranged in an intermediate container 41, also shown schematically. The intermediate container 41 and thus also the conveyor device 40 are arranged in the immediate vicinity of the build area 8 and contact the container wall 6 of the build container 5 from the outside. The conveyor device 40 or the intermediate container 41 can be arranged flush with the working plane 7 or slightly below it. In contrast to the example shown here, a conveyor device 40 could also be assigned to the opposite (left-hand) container wall 6.

During operation of the laser sintering apparatus 1, the coater 16 distributes fresh construction material, for example starting at the, here left, container wall 6 via the build area 8 to the, here right, container wall 6. At the end of an application process, the coater 16 pushes excess construction material, which is fed in front of the coater 16 as a reserve, for example, beyond the here right container wall 6 into the intermediate container 41. The intermediate container 41 extends along an entire side of the build container 5, here along the entire right chamber wall 6 shown in section.

The intermediate container 41 extends with its longitudinal extent parallel to the right-hand container wall 6 in the process chamber 3 and co-operates with a collecting container 42, shown purely schematically, in order to discharge the excess powder 13′ discharged from the construction container 5 by the coater 16 to the collecting container 42. In contrast to the schematic shown here, the collecting container 42 can be spaced further away from the build area 8.

FIG. 2 shows a perspective view of parts of a laser sintering apparatus 1 that are relevant to the invention. A build container 5 of the laser sintering apparatus 1 is enclosed on two opposite sides 5′ by a respective conveyor device 40. Since the conveyor devices 40 are of comparable design, only the conveyor device 40 on the right here is described in more detail below. The conveyor device 40 has a trough-like intermediate container 41, wherein some components of the conveyor device 40 are arranged inside and other components outside the intermediate container 41. The intermediate container 41 is designed here to be open at the top along a large part of its longitudinal extent LEFE (apart from a housing 45). Excess powder can enter the intermediate container 41 by gravity via this open upper side, which preferably faces the coater of the AM machine during operation.

The conveyor device 40 extends with its longitudinal extent LEFE, which corresponds to the longitudinal extent LEFE of the intermediate container 41, along a short side 5′ of the construction container 5 and protrudes beyond it on both sides. The intermediate container 41 contacts the construction container 5 (laterally) directly, wherein an upwardly pointing upper edge 41′ of the intermediate container 41 is arranged slightly below an opening of the construction container 5.

A chain conveyor 50 is arranged in the intermediate container 41, wherein a longitudinal extent of the chain conveyor 50 corresponds to a longitudinal extent LEFE of the intermediate container 41.

To move the chain conveyor 50, the conveyor device 40 comprises a controllable drive 40′, which is arranged on a housing 45 at an end region of the conveyor device 40. The housing 45 closes off the intermediate container 41 at one end and contains, for example, drive components of the chain conveyor 50, in particular a shaft of the chain conveyor 50. The housing 45 forms a downwardly pointing funnel-shaped housing region, which is provided for feeding the excess powder, which is discharged by the chain conveyor 50 from an outlet opening (not visible) of the intermediate container 41, into an overflow container 42 via connecting pipes 44. The overflow container 42 or collecting container 42 is here a component of the laser sintering apparatus 1.

In FIG. 3, parts of the conveyor device 40 from FIG. 2 are shown enlarged in perspective and partly schematically. The chain conveyor 50 is arranged in the elongate intermediate container 41 in such a way that a longitudinal extent of the chain conveyor 50 corresponds to a longitudinal extent LEFE of the intermediate container 41 or a longitudinal extent LEFE of the conveyor device 40. The chain conveyor 50 comprises two endlessly circulating parallel roller chains 63, 63′. The roller chains 63, 63′ are each in engagement with two sprockets (as toothed wheels), with two sprockets being arranged on a common shaft 68 in each case. The shafts 68 are each arranged at the opposite ends of the intermediate container 41. In FIG. 3, only one shaft 68 is visible, the second shaft being arranged in the housing 45 and being able to be rotated by the drive 40′. The chain conveyor 50 is designed such that at least the roller chains 63, 63′ and the conveyor plates 43 located thereon are arranged within the intermediate container 41, i.e. do not protrude beyond the upper edge 41′.

Conveyor plates 43 are mounted at regular intervals between the two roller chains 63, 63′ as conveyor elements 43. The conveyor plates 43 have a rectangular basic shape in section and can be designed as angled plates with an L-profile. In operation, the (bottom) conveyor plates 43 can be guided over a base plate 46 of the intermediate container 41 in a direction of movement BR to transport excess powder 13′ in the intermediate container 41. The direction of movement BR preferably corresponds to the conveying direction of the powder 13′. The powder 13′ is shown here purely schematically. For example, the conveyor plates 43 can rest with a narrow side of one leg on the base plate 46, wherein the powder 13′ is pushed in front of the respective conveyor plates 43 on the base plate 46 in accordance with the direction of movement BR. Accordingly, the chain conveyor 50 has load runs at the bottom.

In the housing 45, the powder 13′ can be discharged from the intermediate container 41 via an outlet opening (not shown) and thus leave the conveyor device 40. Preferably, a second shaft of the chain conveyor 50 is mounted above the outlet opening and/or behind the outlet opening with respect to the direction of movement BR. After a deflection via the second shaft, the two roller chains 63, 63′ return the conveyor plates 43 to the opposite end of the intermediate container 41, lying at the top against the direction of movement BR.

FIG. 4 shows a part of the chain conveyor 50 from FIG. 3 in detail, wherein the other components of the conveyor device are not shown. The two sprockets 51 are visible, which are arranged on the shaft 68. The sprockets 51 can, for example, be firmly connected to the shaft 68. It is also possible that the sprockets 51 are realised as part of the shaft 68. Furthermore, it can be seen that the conveyor plates 43 (as conveyor elements 43) each form a type of L-profile. A guide plate 67 is arranged between the lower part of the roller chain 63′ at the front here (as the load strand) and the upper part of the same roller chain 63′ in order to maintain a certain distance between the upper and lower chain strand during operation. The upper chain centre in this case lies on top of the guide plate 67 and is in contact with it via rollers (not shown) of the roller chain 63′. The guide plate 67 can also have the function of wiping off any powder adhering to the upper chain centre. The two roller chains 63, 63′ have outer chain links 69 and inner chain links 69′ connected thereto. The rollers of the roller chains 63, 63′ are not shown here. The two roller chains 63, 63′ can be constructed in the same way as known roller chains. In contrast to what is shown here, the roller chains 63, 63′ are designed in operation as endless circulating roller chains 63, 63′ (some chain links are not shown in the figure in favour of the visibility of other parts).

FIG. 4 shows that the two sprockets 51 have different sprocket sides 53, 53′. An outward-facing sprocket side 53′ (facing away from the other sprocket on the same shaft) has a number of escape spaces 54 for powder, as described in more detail below. In contrast, an opposite, inward-facing sprocket side 53 is flat in this exemplary embodiment, i.e., without any escape spaces. The two sprockets 51 of a respective shaft 68 can preferably be designed identically (e.g. only laterally twisted).

FIG. 5 shows a perspective view of a sprocket 51, e.g. from FIG. 4, in detail, wherein one sprocket side 53′ is shown here with spaces 54, 54′ for powder. The opposite sprocket side, which is not visible, can preferably be flat or plane, e.g. as shown in FIG. 4. It can also be seen that part of the sprocket 51 is formed by the shaft 68.

The sprocket 51 comprises a plurality of teeth 57, 57′, which are regularly distributed over a circumference of the sprocket 51. The region of the sprocket 51 which lies between two adjacent teeth 57, 57′ forms an inter-tooth region 52 (in order to be able to better distinguish between two adjacent teeth 57, 57′ and alternative spaces 54, 54′ in the description, slightly different reference numerals 57, 57′, 54, 54′ are sometimes arbitrarily assigned here to different teeth and alternative spaces, although the teeth 57, 57′ and alternative spaces 54, 54′ are each constructed identically). In the example shown here, the sprocket 51 has nine separate inter-tooth regions 52, which are each separated from one another by a tooth 57, 57′. Due to the perspective representation and for the sake of clarity, only one inter-tooth region 52 is provided here with a reference sign.

An inter-tooth region 52 begins here at a lower end of a tooth flank 60 of a first tooth 57 and extends to the beginning of an opposite tooth flank 60 of an adjacent, second tooth 57′. In this example, the inter-tooth region 52 comprises a tooth base 56 between these two adjacent teeth 57, 57′. Accordingly, the tooth base 56 connects the tooth flank 60 of the first tooth 57 with the facing tooth flank 60 of the second tooth 57′. In contrast to the example shown here, the inter-tooth region 52 and the tooth base 56 could also have different dimensions.

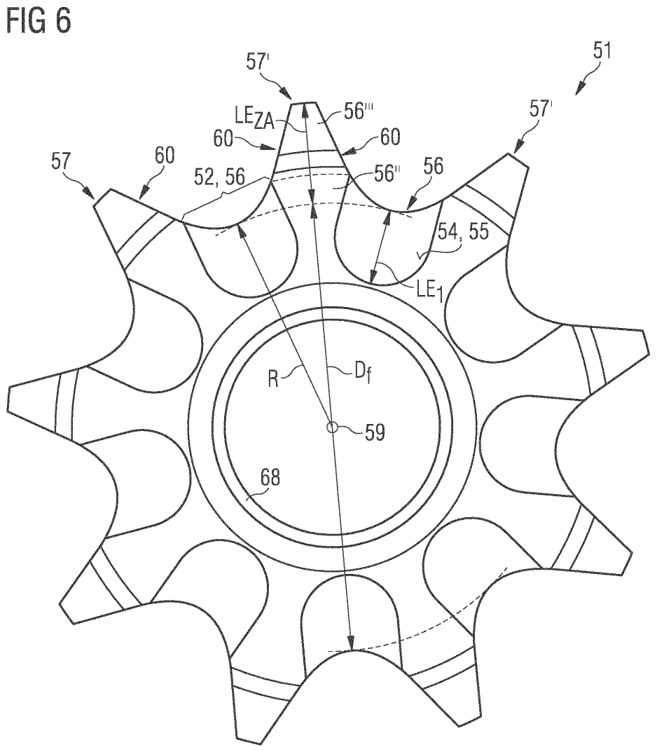

The tooth base 56 between the first tooth 57 and the second tooth 57′ forms a slip-off surface 55 as an escape space 54 for powder. In this example, the slip-off surface 55 forms a slip-off plane 58 for powder. The slip-off plane 58 begins in or at the tooth base 56, in particular starting from a tooth base upper side 56′, and extends in the direction of the shaft 68 or in the direction of a sprocket centre point 59 (FIG. 6). FIG. 5 shows that the slip-off plane 58 is tongue-shaped, in particular a region of the slip-off plane 58 pointing towards the shaft 68. Furthermore, it is shown that the slip-off plane 58 extends along an entire longitudinal extent of the tooth base 56. This means that the slip-off plane 58 extends from the tooth flank 60 of the first tooth 57 to the tooth flank 60 of the adjacent second tooth 57′.

The slip-off plane 58 is formed by a clearance in the tooth base 56 of the sprocket 51. As a result, a width of the tooth base 56 (parallel to the shaft 68), in particular a width of the upper side of the tooth base 56′, is reduced compared to known sprockets. The clearance in the tooth base 56 or the slip-off plane 58 in the inter-tooth region 52 results in a certain part of the tooth base 56, in particular the upper side of the tooth base 56′, being replaced by a material-free space.

The contact surface between the toothed wheel 51 and a chain can be advantageously minimised by such a narrow tooth base upper side 56′. FIG. 5 schematically shows a single chain roller 64 of a roller chain, wherein the chain roller 64 is in engagement with the sprocket 51. It is shown schematically that the chain roller 64 is in direct contact with or rests on the toothed wheel 51 only in the area of the top of the tooth base 56′. In the area of the slip-off plane 58′, the chain roller 64 is spaced from the slip-off plane 58′ during operation.

With respect to its longitudinal extent, the slip-off plane 58′ is arranged at an angle to a longitudinal tooth extent LE_{ZA} of an adjacent tooth 57′. As a result, it can be achieved that powder that strikes the slip-off plane 58′ slips off by means of gravity. Furthermore, the inclination of the slip-off plane 58′ can contribute to powder resting on the tooth base 56 or on the upper side of the tooth base 56′ being diverted away from it, unless the chain roller 64 is resting straight on the respective tooth base 56.

The slip-off planes 58, 58′ between the adjacent teeth 57, 57′ are each formed identically in FIG. 5. However, it would also be possible for different slip-off planes 58, 58′ or escape spaces 54, 54′ to be arranged on the same sprocket 51.

FIG. 6 shows a sprocket 51 according to the invention in a different view, e.g. the sprocket 51 of FIG. 5. It can be seen that the respective inter-tooth region 52 is here identically dimensioned as the associated tooth base 56 (in relation to the longitudinal extent). The tooth base 56 connects the opposing tooth flanks 60 of two adjacent teeth 57, 57′. A tooth longitudinal extent LE_{ZA} is shown schematically on the basis of a centre tooth 57′ here (in the figure above), wherein the tooth 57′ comprises a tooth head 56″ and a tooth foot 56″. The tooth 57′ is connected to the wheel body of the sprocket 51 via the tooth foot 56″.

The wheel body (not shown here in detail) refers to the sprocket 51 without the teeth 57, 57′ arranged on the outside. The wheel body has a circular circumference and is defined by a certain radius R, which is based on the foot circle diameter D_{f}. The sprocket 51 can preferably be designed such that a specific ratio between a longitudinal extent LE₁ of a slip-off surface 55 and a longitudinal tooth extent LE_{ZA} of an associated tooth 57′ is realised. It is also possible that a certain ratio between a longitudinal extent LE₁ of a slip-off surface 55 and the radius R and/or the foot circle diameter D_{f} is achieved.

As shown in FIG. 6, the teeth 57, 57′ can be comparatively large, wherein a longitudinal extent LE_{ZA} can be approximately one fifth of the foot circle diameter D_{f} in each case. FIG. 6 also shows a toothed wheel centre 59 or a sprocket centre 59.

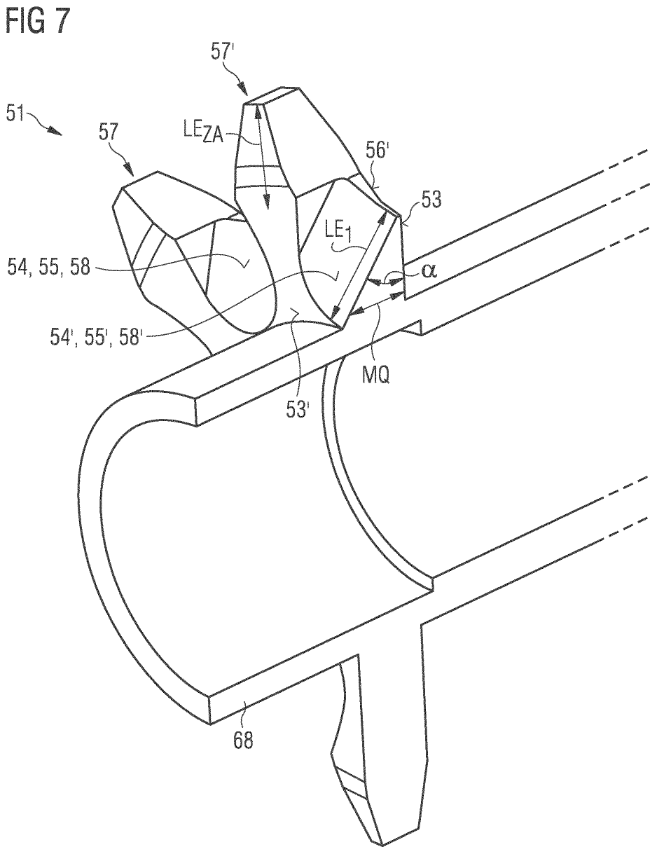

FIG. 7 shows a sectional view of a sprocket 51 according to the invention. It can be seen that the sprocket side 53′ pointing in the direction of observation has an escape space 54, 54′ for powder or a slip-off plane 58, 58′ between two teeth 57, 57′. The opposite side of the sprocket wheel 53 has no such spaces 54. Accordingly, the top of the tooth base 56′ is adjoined by a vertical flat surface, which is approximately parallel to the longitudinal tooth extent LE_{ZA} of the associated tooth 57′ or substantially orthogonal to an axis of rotation of the shaft 68.

The slip-off surface 55′ or slip-off plane 58′ is arranged obliquely with respect to its longitudinal extent LE₁ relative to the longitudinal tooth extent LE_{ZA} of the associated tooth 57′. The slip-off surface 55′ or slip-off plane 58′ is inclined at a certain angle α relative to the longitudinal extent of the tooth LE_{ZA}. The angle α is shown here schematically in relation to the averted sprocket side 53, wherein the corresponding surface is substantially parallel to the longitudinal tooth extent LE_{ZA}. The slip-off surface 55′ or the slip-off plane 58′ here forms an inclined, inherently flat slip-off surface for the powder impinging from above. In principle, however, the slip-off plane does not have to be substantially flat, as is the case here, but could also be curved transversely to the radial direction (e.g. concave), in particular slightly curved, i.e. with a large radius of curvature.

FIG. 7 shows that a material cross-section MQ of the sprocket 51 in the inter-tooth region tapers from the shaft 68 towards the top of the tooth base 56′.

FIG. 9 shows a part of a cross-section of the sprocket 51 parallel to its axis of rotation, whereby the section shown here corresponds to the area of the upper part of the cross-section in the foreground in FIG. 7 (only here with a slightly differently designed slip-off surface).

In FIG. 9, HO denotes a height of the slip-off surface 55 in a direction perpendicular to the axis of rotation of the toothed wheel 51, LE_{R} denotes an axis which also runs perpendicular to the axis of rotation and which intersects an edge between the top of the tooth base 56′ and the longitudinal extent LE₁ of the slip-off surface 55, MQ′ denotes a length of a projection of the slip-off surface 55 or the longitudinal extent LE₁ onto an axis parallel to the axis of rotation of the sprocket 51 (MQ′ also corresponds to the difference between the material cross-section MQ of the sprocket 51 and the width of the tooth base top face 56′) and a the angle between the longitudinal extent LE₁ and the axis LE_{R} (this definition is analogous to the definition of a in the description of FIG. 7). With the basic shape of the tooth space shown, it is sufficient to define two of the above three design parameters HO (height), LE₁ (longitudinal extent) and a (angle) so that the third is necessarily defined. For a given width of the tooth base top surface 56′, two of the design parameters HO (height), LE₁ (longitudinal extent) and a (angle), MQ (material cross-section) and/or MQ′ (difference between the material cross-section MQ and the width of the tooth base top surface 56′) can be determined so that the others are necessarily determined.

Preferably, the inclination of the longitudinal extent LE₁ of the slip-off surface 55 is sufficient so that the powder that impinges on the slip-off surface 55 slides, for example by means of gravity, along the slip-off plane 58 and can be guided away from the inter-tooth region. This means that the angle α, compatible with the other design parameters, in particular with the height HO and/or with the material cross-section MQ and/or with the material cross-section MQ′, is as small as possible. Although a single angle of inclination a is shown in both FIG. 7 and FIG. 9, the slip-off plane 58 or the slip-off surface 55 can have several different angles of inclination. To ensure that a free end of the slip-off surface 55 is as steep as possible, for example, the slip-off plane 58 or the slip-off surface 55 can be divided into two radial portions 80a, 80b, each of which has a different angle of inclination. In FIG. 9, this alternative variant is indicated by a dotted line, which symbolises the course of the surface of a radially inner section 80b of the slip-off surface, which adjoins a radially outer section 80a of the slip-off surface coming from the top of the tooth base 56′ at a bend point 81. In the example shown, this radially outer section 80a again has the angle of inclination a to the axis LE_{R} and from the bend point, the slip-off surface 55 in the inner radial portion 80b then has a smaller angle of inclination, i.e. the slip-off surface 55 is steeper here. Consequently, the height of the slip-off surface 55 is also greater here than in the first variant. This can facilitate the sliding or guiding of the powder. In principle, however, the angle of inclination could also be greater in the radially inner section of the slip-off surface 55, i.e. that the slip-off surface 55 is steeper at the top of the tooth base 56′ and becomes flatter towards the inside, if this would make more sense from a design point of view in individual cases. However, a steeper radially inner end is usually preferred.

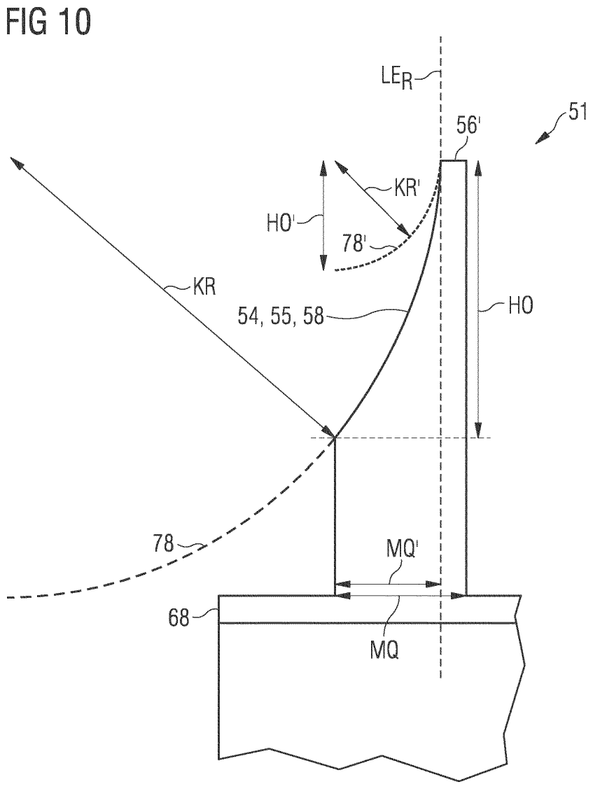

FIG. 10 shows part of a cross-section of an alternative sprocket 51 parallel to its axis of rotation, in particular again an upper part of a cross-section which intersects the sprocket 51 at a position between two teeth 57, 57′ (FIG. 7), i.e. at the position of a slip-off surface 55. In contrast to FIG. 7 and FIG. 9, a circular (arcuate) slip-off plane 58 forms the slip-off surface 55 here. The slip-off plane 58 here extends in the radial direction of an arcuate profile 78 with a radius of curvature KR. This radius of curvature KR determines the curvature or the steepness of the slip-off plane 58. For comparison, an alternative circular arc profile 78′ with a smaller radius of curvature KR′ is shown in FIG. 10 with a dotted line. As can be seen from the illustration in FIG. 10, a free end (here pointing to the left) of the slip-off surface 55 or a slip-off surface end that follows the circular arc profile 78 with the larger radius of curvature KR is steeper than the area of the slip-off surface 55 that follows the circular arc profile 78′ with the smaller radius of curvature KR′. A steeper slip-off surface end is advantageous because it can facilitate the sliding of the powder impinging on the slip-off surface 55 along the slip-off plane 58. It is therefore preferable in most cases to realise a circular (arcuate) slip-off plane 58 forming the slip-off surface 55 with the largest possible radius of curvature (compatible with other design parameters such as, for example, a width of the toothed wheel). Furthermore, the greatest possible height of the slip-off plane 58 is advantageous. As shown in FIG. 10, the height HO corresponding to the larger radius of curvature KR is greater than a height HO′ corresponding to the smaller radius of curvature KR′ would be. A large radius of curvature KR and a large height of a slip-off surface 55 can be compensated for by a wide tooth base top surface 56′, or can be structurally compatible with a wide tooth base top surface 56′.

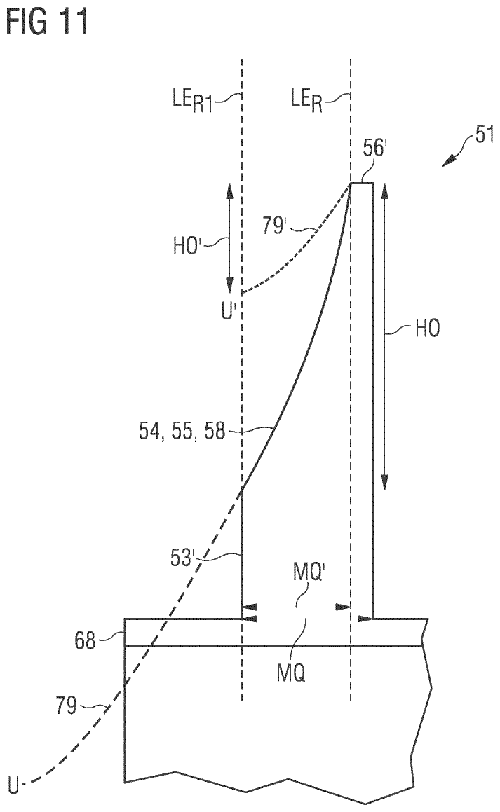

FIG. 11 again shows an upper part of a cross-section of a further alternative sprocket 51 at a position between two teeth 57, 57′ (FIG. 7), i.e. again a cross-section through a slip-off surface 55 of this sprocket 51. In contrast to FIG. 7, FIG. 9 and FIG. 10, a curved but non-circular slip-off plane 58 forms the slip-off surface 55 in FIG. 11. In particular, the slip-off surface 55 in FIG. 11 is formed by a slip-off plane 58 which is parabolic in the radial direction. Although a parabolic slip-off plane 55 is shown in FIG. 11, other curved, non-circular slip-off planes are conceivable, such as a hyperbolic or an elliptical slip-off plane.

In FIG. 11, two alternative two-dimensional parabolic arc profiles 79, 79′ are sketched to illustrate the effect of the exact shape, in order to define the course of such a parabolic slip-off plane, each of which forms a slip-off surface. A first parabolic arc profile 79, which is followed in radial direction by the slip-off plane shown in section (in solid line) in FIG. 10, is a section of an (imaginary) parabola which starts from a (virtual) origin U which lies outside the material cross-section of the sprocket. In contrast, the alternative second parabolic arc profile 79′, shown here only as a dotted line, is a section of an (imaginary) parabola which starts from a (virtual) origin U′ which lies on an axis LERIwhich is perpendicular to the axis of rotation of the sprocket 51 and which lies in a plane corresponding to the sprocket side 53′. The origin U′ is therefore closer to the axis LE_{R} than the origin U.

As can be seen from the representation of FIG. 11, a radially outer free end of the slip-off surface (free slip-off surface end), which corresponds to the parabolic arc profile 79 with the origin U further away from the sprocket, is steeper than the free end of a slip-off surface which corresponds to the parabolic arc profile 79′. A steeper free end of the slip-off surface is advantageous because it can facilitate the sliding of the powder, which impinges on the corresponding partial region of the slip-off surface 55, along the slip-off plane 58. Advantageously, a curved, non-circular (e.g. parabolic or hyperbolic or elliptical) slip-off plane forming the slip-off surface can thus be realised in such a way that its origin (compatible with other design parameters such as, for example, the width of the sprocket) is as far away as possible from the axis LE_{R}. It can also be advantageous if the origin U is lower than the axis of rotation of the sprocket 51. This facilitates the sliding or guiding of the powder.

FIG. 8 shows a purely schematic part of a sprocket 51 according to the invention. A chain roller 64 of a chain is shown between two adjacent teeth 57, 57′, which is in engagement with the sprocket 51. The inter-tooth region 52 here comprises a clearance 61 as an escape space 54 for powder. The clearance 61 is designed in such a way that the engaged chain roller 64 is spaced apart from a wheel body 62 of the toothed wheel 51 by a distance a. The chain roller 64 is supported only by two contact areas 65, 65′ on the two opposing teeth 57, 57′, with one contact area 65, 65′ being formed by a tooth 57, 57′ in each case. The contact areas 65, 65′ are arranged on the respective tooth flanks 60, in particular in a convex section.

In this embodiment, the chain roller 64 rests on the sprocket 51 only via two narrow, elongated contact surfaces 65, 65′ in the region of the teeth 57, 57′. In the area of the inter-tooth space 52, in particular between the two contact areas 65, 65′, there is no direct contact between the chain roller 64 and the (remaining) sprocket 51 during operation. In this example, the clearance 61 is formed as a material-free space such that the inter-tooth region 52 is formed without a tooth base. A width b of the inter-tooth region 52 is smaller by a certain amount than an outer diameter D of the roller chain 64. The clearance 61 in the inter-tooth region 52 can be used to ensure that the chain roller 64 resting on it is spaced apart from powder 13′, which is present in the inter-tooth region 52.

Lastly, it is pointed out once again that the conveyor devices described in detail above are merely examples of embodiments which can be modified by the skilled person in a wide variety of ways without departing from the scope of the invention. For example, the alternative spaces of the sprockets shown in the respective exemplary embodiments can be interchanged and/or combined as desired. The sprockets in the inter-tooth regions could also have a slip-off surface or slip-off planes on the other side, for example on the “inner” side facing the other second sprocket arranged on the same shaft in the figures. The sprockets could also have slip-off surfaces or slip-off planes on both sides in the inter-tooth regions, so that the upper side of the tooth base is shifted more towards the centre parallel to the axis of rotation of the toothed wheel and the powder material can slip off the upper side of the tooth base on both sides. Furthermore, the use of the indefinite articles “a” or “an” does not exclude the possibility that the relevant features may also be present more than once.

### LIST OF REFERENCE SIGNS

1 apparatus for additive manufacturing/laser sintering apparatus
2 component/object
3 process space/process chamber
4 chamber wall
5 construction container/container
5′ side
6 container wall
7 working plane
8 build area
10 support
11 base plate
12 build platform
13, 13′ construction material
14 storage container
15 construction material in the storage container
16 coater
17 radiant heater
18 sensor arrangement/camera
20 irradiation apparatus/exposure apparatus
21 laser
22 laser beam/energy beam
23 deflection apparatus/scanner
24 focusing device
25 coupling window
29 control unit
30 control device
32 terminal
33 bus
40 conveyor device
40′ drive
41 intermediate container
41′ top edge
42 overflow container/collecting container
43 conveyor element/conveyor plate
44 connecting pipes
45 housing
46 bottom plate
50 chain-driven conveyor/chain conveyor
51 toothed wheel/sprocket
52 inter-tooth region
53, 53′ sprocket side
54, 54′ escape space
55, 55′ slip-off surface
56 tooth base
56′ tooth base top side
56″ tooth foot
56″ tooth head
57, 57′ teeth
58, 58′ slip-off plane
59 toothed wheel centre point/sprocket centre point
60 tooth flank
61 clearance
62 wheel body
63, 63′ chain/roller chain
64 chain roller
65, 65′ contact area
67 guide plate
68 shaft
69 outer link
69′ inner link
78, 78′ two-dimensional circular arc profile
79, 79′ two-dimensional parabolic arc profile
80a, 80b radial portions
81 bend point
α angle
a distance
b width
BS irradiation control data
BR movement direction
D chain roller diameter
D_{f} foot circle diameter
H horizontal direction
HS heating control data
HO, HO′ height of slip-off plane
KR, KR′ radius of curvature
LE₁ longitudinal extent
LE_{FE} longitudinal extent
LE_{ZA} longitudinal tooth extent
LE_{R}, LERI axis
MQ, MQ′ material cross-section
PS process control data
R wheel body radius
ST coating control data
TS support control data
V vertical direction
U, U′ origin

1. A conveyor device for an apparatus for the additive manufacture of at least one component from a powder construction material by at least partial selective solidification of the construction material, comprising:
a chain-driven conveyor, with at least one toothed wheel, wherein at least one inter-tooth region between two adjacent teeth of the toothed wheel comprises an escape space for the powder construction material.

2. The conveyor device according to claim 1,
wherein the toothed wheel has two or more spaced-apart, escape spaces for the construction material, and/or
wherein the escape space for the construction material comprises a clearance in the inter-tooth region.

3. The conveyor device according to claim 1, wherein the escape space comprises a slip-off surface for guiding the construction material away from the inter-tooth region.

4. The conveyor device according to claim 3, wherein the slip-off surface is formed by a tooth base between two adjacent teeth, wherein the slip-off surface connects two adjacent teeth with each other.

5. The conveyor device according to claim 3, wherein the toothed wheel has a material cross-section for forming the slip-off surface, which material cross-section tapers towards the tooth base.

6. The conveyor device according to claim 3, wherein the toothed wheel has one of the following elements for forming the slip-off surface:
at least one slip-off plane extending from the tooth base, which is arranged obliquely to a tooth longitudinal extent-(LE_{ZA});
at least one curved slip-off plane extending from the tooth base; and
at least two slip-off planes extending from the same tooth base, which are arranged obliquely to a longitudinal tooth extent, forming a specific angle to one another.

7. The conveyor device according to claim 4, wherein an upper side of the tooth base, which points away from a toothed wheel center, is concave at least in sections.

8. The conveyor device according to claim 3,
wherein a ratio between a longitudinal extent of the slip-off surface and a longitudinal extent of an associated tooth is at least 1:1.5 and/or at most 1:0.5, and/or
wherein a ratio between a longitudinal extent of the slip-off surface and a radius of a wheel body of the toothed wheel at least 1:5 and/or at most 1:2.

9. The conveyor device according to claim 2, wherein the escape space for the construction material comprises a clearance which is designed such that a certain distance is formed between a chain roller of a chain in engagement with the sprocket and a tooth base.

10. The conveyor device according to claim 2, wherein the escape space for the construction material comprises a clearance which is designed in such a way that a chain in engagement with the sprocket is supported via two contact regions on two opposing teeth, leaving a distance between a chain roller of the chain and a wheel body of the toothed wheel.

11. The conveyor device according to claim 1, wherein the conveyor device has a channel-like, intermediate container for receiving construction material, wherein the chain-driven conveyor acts in the intermediate container, is arranged at least partially therein.

12. The conveyor device according to claim 11, wherein the chain-driven conveyor has at least one conveying element which can be moved in the intermediate container along the longitudinal extent thereof, in relation to an outlet opening of the intermediate container.

13. An apparatus for the additive manufacture of at least one component, having a feed apparatus for feeding a powder construction material into a process space, an irradiation apparatus for selectively at least partially solidifying the construction material by irradiation with at least one energy beam, and a conveyor device according to claim 1.

14. The apparatus according to claim 13, wherein the conveyor device is designed to convey unused construction material away from a build area in the process space, for conveying construction material from an intermediate container of the conveyor device into an overflow container, and/or
wherein the conveyor device can be moved at least partially between a working position and a service position, and/or
wherein the apparatus comprises a temperature lock for generating a temperature difference in the conveyor device.

15. A method for the additive manufacture of at least one component, in an apparatus according to claim 13, comprising the following steps:
feeding a powder construction material into a process space, by applying construction material in layers to a build area,
irradiating the construction material with at least one energy beam in order to selectively at least partially solidify the construction material,
conveying construction material by means of a conveyor device, which has a chain-driven conveyor, with at least one toothed wheel, wherein at least one inter-tooth region between two adjacent teeth of the toothed wheel comprises an escape space for the powder construction material,
transferring excess construction material into an intermediate container of the conveyor device and transferring the construction material by means of the conveyor device from the intermediate container into an overflow container which is associated with the conveyor device.
